(19) United States
(12) Patent Application Publication
(10) Pub. No.: US 2007/0185905 A1
(43) Pub. Date: Aug. 9, 2007

(54) Single session object-based navigation for progressive disclosure

(76) Inventors: IIja Fischer, Heidelberg (DE); Juergen Schmerder, Wiesloch (DE)

Correspondence Address: KENYON & KENYON LLP, RIVERPARK TOWERS, SUITE 600, 333 W. SAN CARLOS ST., SAN JOSE, CA, 95110, US

(21) Appl. No.: 11/319,513

(22) Filed: Dec. 29, 2005

(51) Int. Cl. G06F 17/00

(52) U.S. Cl. 707/104.1

(57) ABSTRACT

A system and method for manipulating the fields of a business object using a floorplan is used. The object based navigation system may create a portal page connection between a object based navigation system and a pattern application. The object based navigation system may receive a request for a first model of a business object. The object based navigation system may transmit the first model to the pattern application via the portal page connection. The object based navigation system may receive a request for a second model of the business object. The object based navigation system may transmit the second model to the pattern application via the portal page connection.

### BACKGROUND

The present invention relates to a system for working with business objects and, in particular, using multiple models to manage the fields of a business object.

Large software applications are often composed of unmanageably large amounts of executable code. In order to facilitate creation and management of large software systems, then, the systems are often composed of many different business objects. Business objects are software components that encompass user interfaces, data, business rules, communication components and any other code that may relate to their function.

In order to simplify design of these large systems, business objects are often defined as collections of logically related functions and data. A large application designed to facilitate a typical business may have many different business objects. An ordering business object may be used to handle incoming orders or changes to existing orders. A shipping business object may be implemented to handle all shipping related tasks, such as arranging for deliveries or determining shipping times and costs. Business objects may handle some tasks independently while communicating with other business objects to complete other tasks.

FIG. 1 illustrates in a block diagram one system 100 for manipulating business objects. A system may have a set of business objects 110, each business object having a number of fields 1-n 120. Each field 120 represents at least one data value 125 and at least one action 130 stored in the business object 110. Each field 120 may have a respective relation 130 indicating how it interacts with other respective fields 120 of the business objects 110. A user may view the field 120 using a portal page 140. When a portal page 140 is opened, that business object 110 is locked to prevent a second user from manipulating the business object as it is being manipulated by the first user.

What is needed is a method of being able to switch from a first program instance for manipulating the fields of a business object to a second program instance without having to exit the first program instance.

### BRIEF DESCRIPTION OF THE DRAWINGS

FIG. 1 illustrates in a block diagram one system for manipulating business objects.

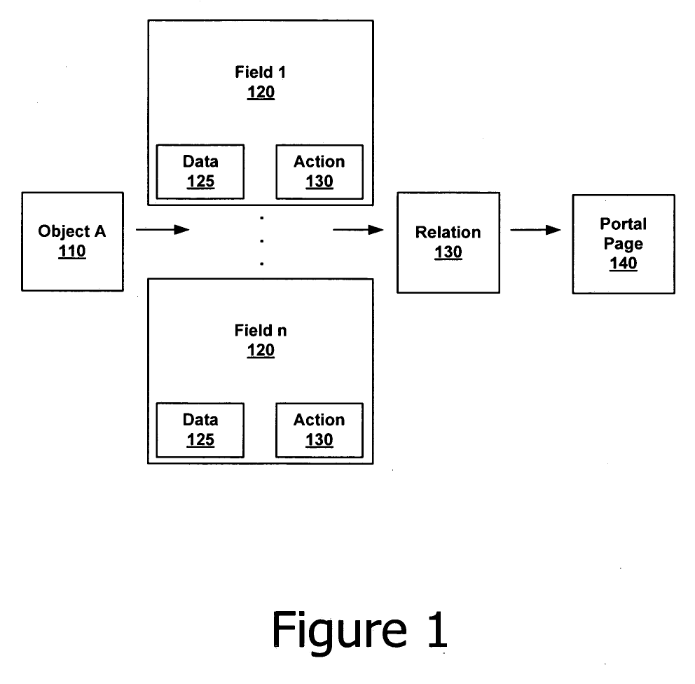

FIG. 2 illustrates a possible configuration of a computer system to implement the application components under the present invention.

FIG. 3 illustrates one embodiment for a system to manipulate the fields of business objects.

FIG. 4 illustrates in a flowchart one embodiment of a method for manipulating the fields of business objects.

FIG. 5 illustrates one embodiment for a system to manipulate the fields of business objects under the present invention.

FIG. 6 illustrates in a flowchart one embodiment of a method for manipulating the fields of business objects 302 under the present invention.

### DETAILED DESCRIPTION

A system and method for manipulating the fields of a business object using a floorplan is disclosed. The object based navigation system may create a portal page connection between a object based navigation system and a pattern application. The object based navigation system may receive a request for a first model of a business object. The object based navigation system may transmit the first model to the pattern application via the portal page connection. The object based navigation system may receive a request for a second model of the business object. The object based navigation system may transmit the second model to the pattern application via the portal page connection.

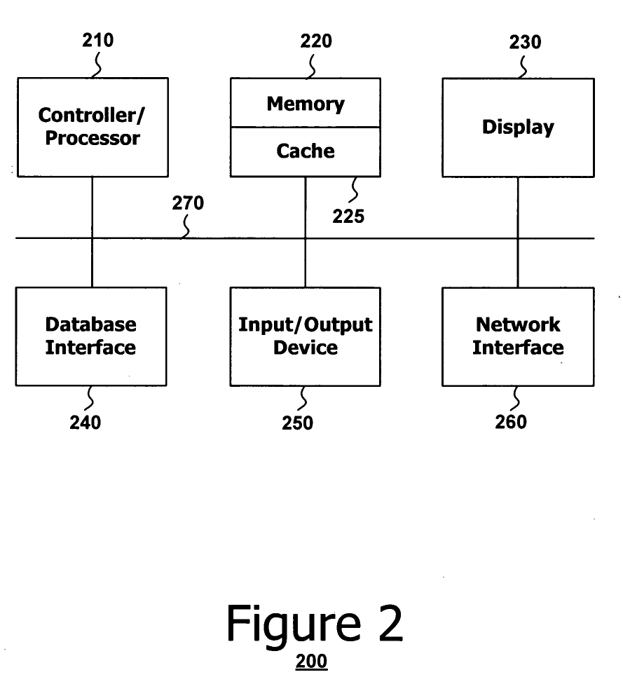

FIG. 2 illustrates a possible configuration of a computer system 200 to implement application components under the present invention. The computer system 200 may include a controller/processor 210, a memory 220 with a cache 225, display 230, database interface 240, input/output device interface 250, and network interface 260, connected through bus 270.

The controller/processor 210 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 220 may include volatile and nonvolatile data storage, including one or more electrical, magnetic or optical memories such as a RAM, cache, hard drive, CD-ROM drive, tape drive or removable storage disk. The memory may have a cache 225 to speed access to specific data.

The Input/Output interface 250 may be connected to one or more input devices that may include a keyboard, mouse, pen-operated touch screen or monitor, voice-recognition device, or any other device that accepts input. The Input/Output interface 250 may also be connected to one or more output devices, such as a monitor, printer, disk drive, speakers, or any other device provided to output data.

The network interface 260 may be connected to a communication device, modem, network interface card, a transceiver, or any other device capable of transmitting and receiving signals over a network. The components of the computer system 200 may be connected via an electrical bus 270, for example, or linked wirelessly.

Client software and databases may be accessed by the controller/processor 210 from memory 220 or through the database interface 240, and may include, for example, database applications, word processing applications, the client side of a client/server application such as a billing system, as well as components that embody the decision support functionality of the present invention. The computer system 200 may implement any operating system, such as Windows or UNIX, for example. Client and server software may be written in any programming language, such as ABAP, C, C++, Java or Visual Basic, for example.

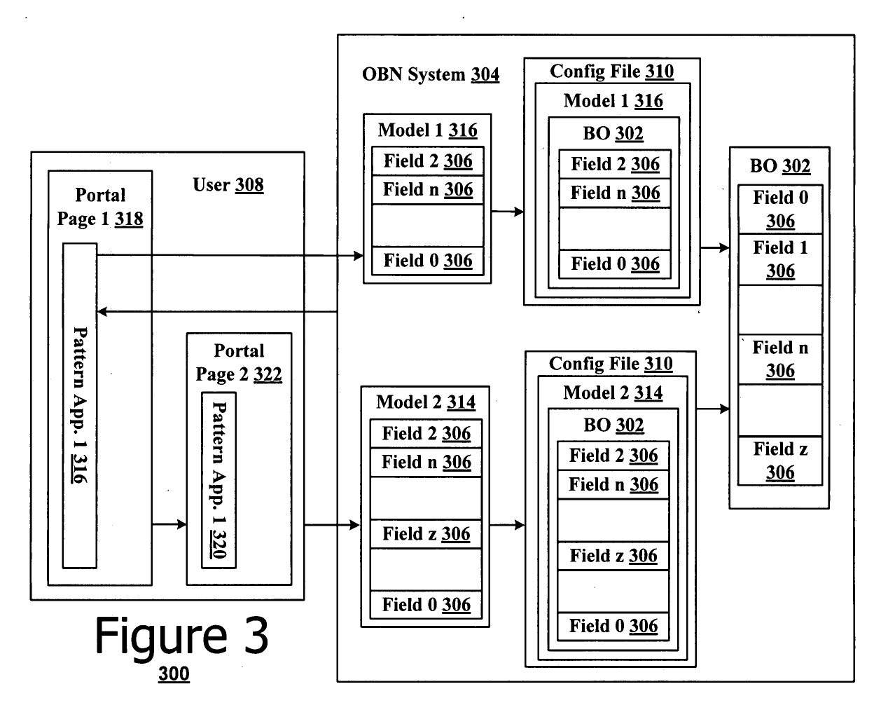

FIG. 3 illustrates one embodiment for a system 300 to manipulate the fields of business objects. A set of one or more business objects 302 may be stored on an object based navigation (OBN) system 304. The fields 306 of the business object 302 may be accessed by a user 308 using a model, such as a floorplan. The model may be generated from a configuration file 310, specifying which fields 306 are available to be manipulated by the user. These manipulations may include entry of data into a field 306, editing a field 306, or other actions. Various types of models may be used. A first floorplan, e.g., Model 1, 316 may allow access to only the most often used fields 306 of a business object 302. By focusing on a smaller percentage of the fields, the usability of the floorplan is greatly improved since the user sees only the most relevant fields for a particular situation. In addition, the runtime efficiency may be greatly increased. Another floorplan, e.g., Model 2, 314 may allow access to most or all of the fields 306 of the business object 302. Other models or floorplans may also be used, e.g., as a guide to specify the chronological order in which the fields 306 are manipulated. As each configuration file 310 contains a single model, a user may create a pattern application in a portal page 318 to access the business objects 302. To access a field 302 that is not a part of the first floorplan 316, the pattern application should close the first portal page 318 and open a second pattern application 320 in a second portal page 322 to generate a floorplan containing that field 302.

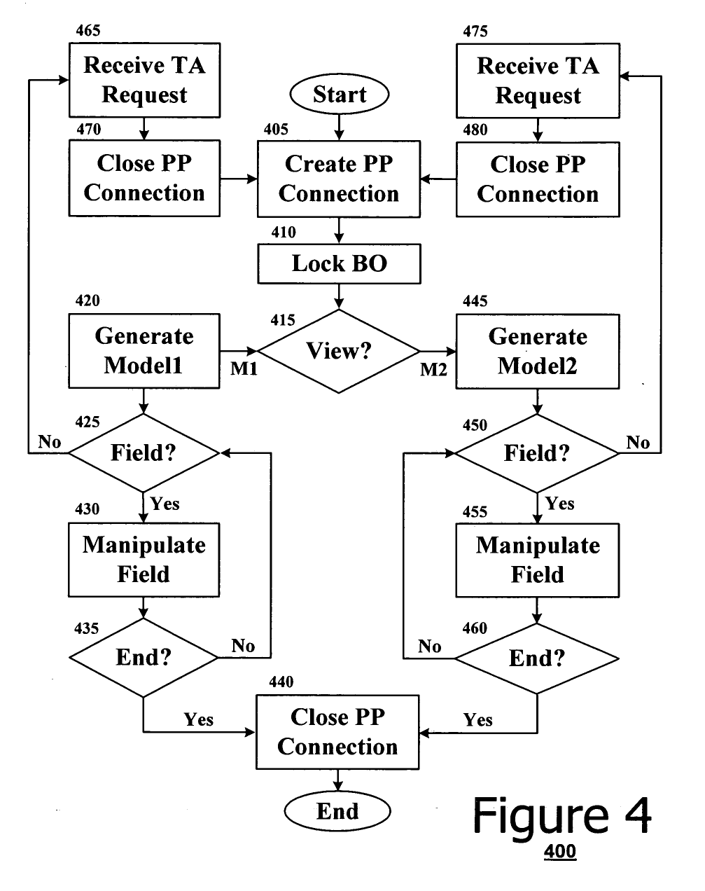

FIG. 4 illustrates in a flowchart one embodiment of a method 400 for manipulating the fields 304 of business objects 302. The user 308 may create a portal page connection with the OBN system 304 (Block 405). The OBN system 304 may lock the business object (BO) 302 (Block 410). If the user selects the first model view (Block 415), the OBN system 304 may generate the first model view (Block 420). If the fields 306 to be entered are present in the first model (Block 425), the user may manipulate the fields 306 (Block 430), until the session is completed (Block 435). The portal page connection may be closed at that time (Block 440). If the user selects the second model view (Block 415), the OBN system 304 may generate the second model view (Block 445). If the fields 306 to be entered are present in the second model (Block 450), the user may manipulate the fields 306 (Block 455), until the session is completed (Block 460). The portal page connection may be closed at that time (Block 440). If the fields 306 to be entered are not present in the first model (Block 425), the OBN system 304 receives a target address request (Block 465). The portal page connection may be closed at that time (Block 470), and the OBN system 304 creates a new portal page connection based on the new target address to generate a new model (Block 405). If the fields 306 to be entered are not present in the second model (Block 450), the OBN system 304 receives a target address request (Block 475). The portal page connection may be closed at that time (Block 480), and the OBN system 304 creates a new portal page connection based on the new target address to generate a new model (Block 405).

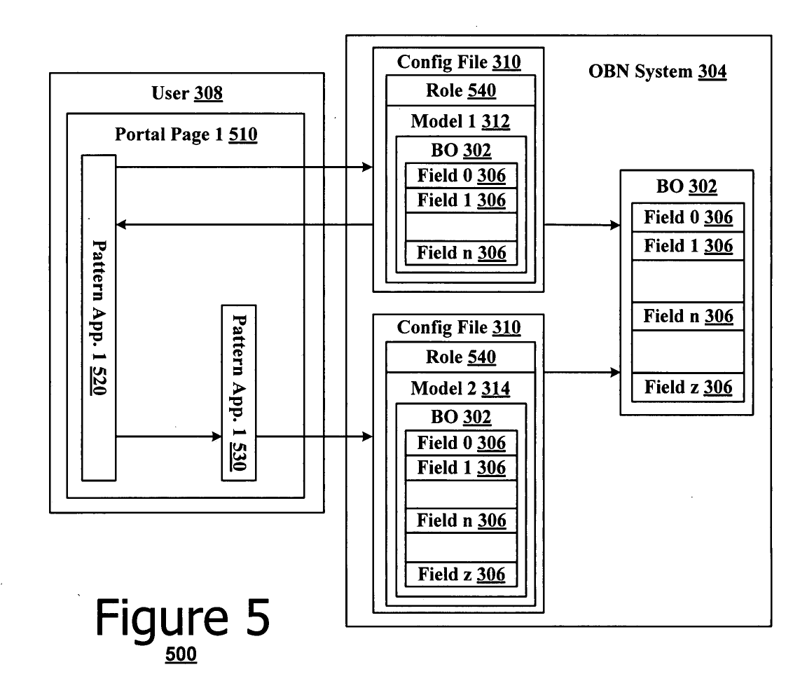

FIG. 5 illustrates one embodiment for a system 500 to manipulate the fields of business objects under the present invention. The user 308 may create in a first portal page connection 510 a first pattern application 520 to access a first model 312 of a business object 302 by requesting a first model identifier. The user 308 may create in the first portal page connection 510 a second pattern application 530 to access a second model 312 of a business object 302 by requesting a second model identifier. Each configuration file 310 may use a role permission identifier 540 to determine whether a user has permission to access a model. The role permission identifier 540 may be assigned based on the user's job, project assignment, or other criteria, assigning separate permission levels for each.

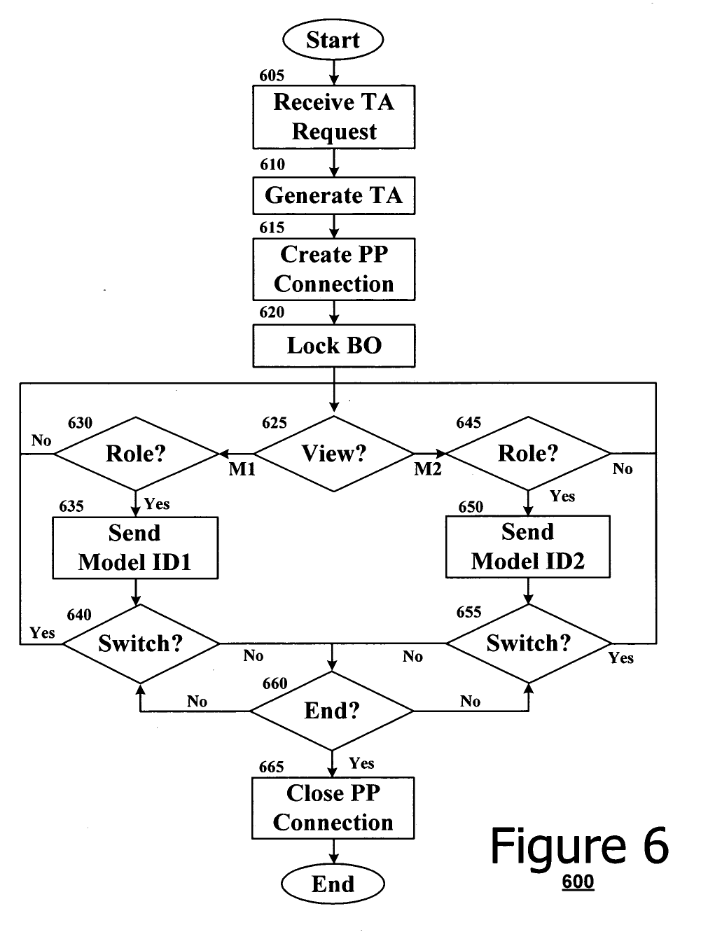

FIG. 6 illustrates in a flowchart one embodiment of a method 600 for manipulating the fields 304 of business objects 302 under the present invention. The OBN system 304 may receive a request for a target address from a user 308 (Block 605). The OBN system 304 may generate the target address (Block 610). The OBN system 304 may create a portal page connection 510 with the user 308 (Block 615). The OBN system 304 may lock the business object (BO) 302 (Block 620). If the user selects a first model 312 (Block 625), and the user 308 has the proper role (Block 630), the OBN system 304 may generate a first model 312 (Block 635). If the user 308 requests to switch models (Block 640), and the user 308 has the proper role (Block 645), the OBN system 304 may generate a second model 314 (Block 650). The user may switch back during the session (Block 655). Once the session is over (Block 660), the OBN system 304 may close the portal page connection 510 (Block 665).

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. In a computer system, a method comprising:
creating a portal page connection between a object based navigation system and a pattern application;
receiving a request for a first model of a business object;
transmitting the first model to the pattern application via the portal page connection;
receiving a request for a second model of the business object; and
transmitting the second model to the pattern application via the portal page connection.

2. The method of claim 1, further comprising associating the first model with a role of a user of the pattern application.

3. The method of claim 1, further comprising denying access to the second model based on a role of a user of the pattern application.

4. The method of claim 1, further comprising:
identifying the first model with a first model identifier; and
identifying the second model with a second model identifier.

5. The method of claim 1, further comprising locking the business object upon creation of the portal page connection.

6. The method of claim 1, further comprising:
generating the first model from a first configuration file; and
generating the second model from a second configuration file.

7. The method of claim 1, further comprising identifying the portal page connection with a target address.

8. Computer readable medium storing a set of program instructions that, when executed by a client device, cause the client device to:
creating a portal page connection between a object based navigation system and a pattern application;
receiving a request for a first model of a business object;
transmitting the first model to the pattern application via the portal page connection;
receiving a request for a second model of the business object; and
transmitting the second model to the pattern application via the portal page connection.

9. The set of program instructions of claim 8, further comprising associating the first model with a role of a user of the pattern application r.

10. The set of program instructions of claim 8, further comprising denying access to the second model based on a role of a user of the pattern application.

11. The set of program instructions of claim 8, further comprising:
identifying the first model with a first model identifier; and
identifying the second model with a second model identifier.

12. The set of program instructions of claim 8, further comprising locking the business object upon creation of the portal page connection.

13. The set of program instructions of claim 8, further comprising:
generating the first model from a first configuration file; and
generating the second model from a second configuration file.

14. The set of program instructions of claim 8, further comprising identifying the portal page connection with a target address.

15. A business object navigation system comprising:
a data storage medium to store a first configuration file to generate a first model of a business object during runtime and a second configuration file to generate a second model of a business object during runtime;
a network portal to create a portal page connection with a pattern application; and
a processor to transmit the first model and the second model to the pattern application via the portal page connection upon request from the pattern application.

16. The business object navigation system of claim 15, wherein the data storage medium associates the first model with a role of a user of the pattern application.

17. The business object navigation system of claim 15, wherein the processor denies access to the second model based on a role of a user of the pattern application.

18. The business object navigation system of claim 15, wherein the data storage medium identifies the first model with a first model identifier and the second model with a second model identifier.

19. The business object navigation system of claim 15, wherein the portal page connection locks the business object.

20. The business object navigation system of claim 15, wherein the portal page connection is identified with a target address.
